(19) United States
(12) Patent Application Publication
(10) Pub. No.: US 2012/0268255 A1
(43) Pub. Date: Oct. 25, 2012

(54) METHOD AND SYSTEM FOR MANAGING OBJECTS IN A PLURALITY OF DISTRIBUTION PLATFORMS

(76) Inventor: Gilles Bennejean, Charenton Le Pont (FR)

(21) Appl. No.: 13/499,361

(22) PCT Filed: Oct. 1, 2010
(86) PCT No.: PCT/FR2010/052083

§ 371 Date: Jun. 29, 2012

(30) Foreign Application Priority Data
Oct. 1, 2009 (FR) 09/04692

(51) Int. Cl. H04Q 5/22

(52) U.S. Cl. 340/10.42

(57) ABSTRACT

A method and a system for managing objects arranged on a support and each comprising a non-contact label, said method comprises the following steps: detection of non-contact labels, comprising a sub-step of interrogation of the non-contact labels in such a way as to receive identification data of each object by at least one non-contact reading device; transmission of the data to a server; determination of at least one event relating to the object by the processing device of the server; transmission of the data relating to the event and identification data associated with a technical platform; and processing of the data relative to the event in such a way as to generate criteria relating to the management of the objects.

### BACKGROUND

1. Technical field of the invention

The invention relates to a method and system for managing objects in a plurality of distribution platforms.

This invention relates to the field of mechanisms for processing data collected from non-contact supports for information relating to the identification of objects within a plurality of distribution platforms.

2. Prior art

Within conventional distribution platforms, such as jewellery shops, perfume shops or shops belonging to the field of mass distribution, the objects are labelled with non-contact supports for information such as barcodes.

These barcodes are associated with the objects in order to identify them, and are read using a manual or fixed optical device, located on a terminal acting as a cash register.

A major disadvantage with this device is linked to the method of reading which requires an individual reading of each barcode associated with an object which generates extremely long processing times which are not adapted to this type of operating platform wherein the objects are numerous, in particular within the framework of management of these objects relating to the management of various ranges of objects, the analysis of performance linked to sales, the improvement of the management of inventories thanks to visibility concerning how it evolves in real time, the reduction of the time devoted to inventories and to the control of markdowns.

In order to overcome this disadvantage, it is known from prior art document U.S.2009101713 which describes an inventory management system for a shop, using at least one non-contact reading device relating to a radiofrequency identification scanner (RFID) able to receive data coming from RFID labels simultaneously and without having to manipulate the objects.

However, the disadvantage of such a system resides in the fact that the user stops in front of each object in order to bring the reading or interrogation means into the close vicinity of the information support. This technique is therefore meticulous and long and is therefore not adapted to a complete inventory, or for a search linked to all of the objects present within a distribution platform at a precise moment.

In addition, the user of this system cannot know at any instant and immediately the precise and certain status of the number and of the nature of the objects displayed on supports for objects within the distribution platform and its storage zone.

By way of example, the observation of a theft of an object displayed on a support for objects cannot be realised until after the carrying out of a long and meticulous inventory.

### SUMMARY OF THE INVENTION

This invention aims to overcome the problem linked to the technical difficulties encountered in order to improve the traceability in real time of the objects present within a plurality of distribution platforms.

The invention proposes to improve the compatibility and the interoperability of systems and methods for managing objects using a mechanism for collection in real time of data relating to objects displayed on/in supports for objects.

To do this, an aspect of the invention relates to a method for managing objects arranged on a support and each comprising a non-contact label, characterised in that it comprises the following steps:
detection of non-contact labels comprising a sub-step of interrogation of said non-contact labels in such a way as to receive identification data of each object by at least one non-contact reading means;
transmission of said data to a server;
determination of at least one event relating to said object by the processing means of said server;
transmission of the data relating to said event and identification data associated with a technical platform;
processing of this data relative to said event in such a way as to generate criteria relating to the management of the stored objects.

According to particular embodiments:
the step of detection is carried out continuously;
said event data relates to actions carried out on an object, said actions being deduced from the processing of the data transmitted to the server corresponding to the various steps of detection or of loss of detection by at least one reading means succeeding an initial step of loss of detection of the non-contact label of said object by said at least one non-contact reading means of the support for objects wherein is initially located said object, according to a predefined parameters relative to time.

The invention also relates to a system for managing objects comprising a technical platform connected by a communications network to at least one distribution platform, said distribution platform comprising at least one support for objects connected to a server, said at least one support for objects comprising at least one non-contact reading means arranged in said support in such a way as to receive the archived data in non-contact labels associated with each of the juxtaposed objects included in said support for objects, said distribution platform comprising a server able to exchange data with said technical platform.

According to particular embodiments:
the technical platform comprises a management server and a database comprising information associated with object identifiers;
the server comprises means of processing able to implement a computer code able to process the data received in such a way as to identify an event relating to an action carried out on an object;
the distribution platform is a commercial company;
the support for objects is a display case;
the non-contact label is a RFID and/or NFC chip;
the non-contact reading means relates to at least one antenna integrated into the support for objects in such a way that said at least one antenna is not visible;
the non-contact reading means relates to a plurality of coupled antennas connected to a multiplexer;
said at least one antenna is made from a flexible material;
said at least one antenna has a field of detection limited to the volume or to the surface of the support for objects;
said at least one antenna is connected to the server by wireless communications means;
the server is comprised in the distribution platform;
the server is connected to a terminal of the cash register type, and
the terminal comprises a non-contact reading means.

### BRIEF DESCRIPTION OF THE DRAWINGS

Other characteristics and advantages of the invention shall appear when reading the following description, in reference to the annexed figures, which show:

FIG. 1, a diagrammatical view of an embodiment according to the invention, and

FIG. 2, a representation of an element of the support: the plate of a display window block comprising a reading means.

For increased clarity, identical or similar elements are marked by identical reference signs on all of the figures.

### DETAILED DESCRIPTION OF THE PREFERRED EMBODIMENT(S)

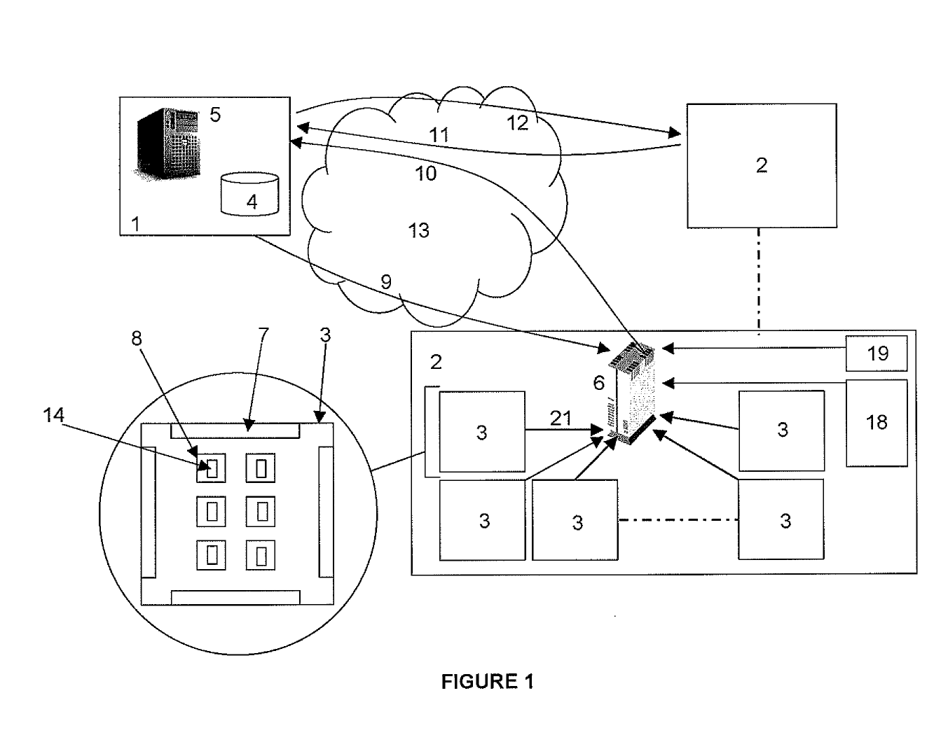

In an example embodiment of the system according to the invention, FIG. 1 relates to a system comprising:
a technical platform 1, and
a distribution platform 2.

The technical platform 1 comprises in particular a management server 5, associated with a database 4.

The management server 5 comprises means of processing able to execute a code relating to a computer application for the processing of the data that it receives from the distribution platforms 2.

This management server 5 is connected to a database 4. This database archives information relating to the various objects 8 displayed within distribution platforms 2. The information data relating to an object is associated with an identifier of said object.

This database further comprises a set of data relating to a stock stored within the distribution platforms as well as within the technical platform.

The identifier is also named in what follows as identification data.

The various distribution platforms 2 are all connected to this technical platform 1 using means of communication 13.

The distribution platform 2 comprises a set of supports for objects 3 in or on which the objects 8 are displayed for the purposes of being sold.

These supports relate for example to display windows (or display window block), or to shelves.

This distribution platform relates for example to a commercial company such as a shop, a jewellery shop, a perfume shop or a shop belonging to the field of mass distribution.

These supports for objects include at least one non-contact reading means of the antenna type.

In another embodiment, the non-contact reading means relates to a plurality of coupled antennas connected to a multiplexer.

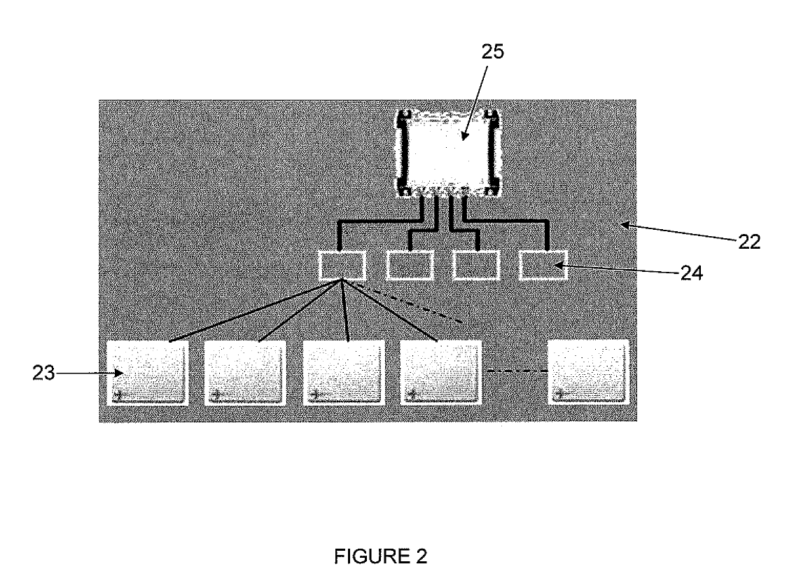

In reference to FIG. 2, in another embodiment, this reading means comprises:
an RFID reader 25,
a multiplexing system,
an antenna referred to as an intelligent antenna 24 which is in fact a meshing of multiplexed antennas 23

This multiplexing system is based on an intelligent electronic multiplexing of the antenna outputs of the RFID reader 25 in order to duplicate the number of antennas without multiplying the number of RFID readers.

In this multiplexing system the switching on each output of the multiplexer is driven by the software application implemented by the means of processing of the server 6.

This multiplexing system provides to duplicate the antenna outputs from 1 to 8 or 16 outputs.

In this multiplexing system, a multiplexer can supply antennas covering several display windows. The controlling of the active outputs of the multiplexer by the software application makes it possible to precisely identify which antenna is sending information (or an event linked to an object) and as well in which display window the identified object (the identified piece of jewellery) is located.

This multiplexing is carried out automatically between various smaller antennas constituting a meshing arranged under a plate 3 and 22 included in a display window block and supporting the objects.

This rigid unit constitutes of a larger size equivalent to the size of a display window block. The multiplexing is this time automatic as it is not required to precisely know which antenna within the meshing has read the identified object (identified piece of jewellery).

In order to equip a display window block, a plate 22 is arranged under the jewellery and behind the jewellery at the bottom of the display window.

This antenna and RFID reader are integrated into the support for objects, or arranged in such a way, that it does not hinder the field of vision of a customer who is observing the objects of this support for objects 3, and that it is at a sufficient distance from the objects of the support for objects 3 to detect only the objects displayed on this support 3.

This antenna is made from a relatively flexible material for example from a material belonging to the polyolefin family. Such a material is a polymer of which the cost is low and corresponds to inert plastic.

This antenna has an optimal form allowing it to be able to interrogate one or several non-contact labels simultaneously. This form can for example be ovoid shaped.

In this embodiment, this antenna relates to a loop, a strand, or to any other elements able to generate an electric or electromagnetic field.

This antenna is sensitive to an electric or electromagnetic field and delivers an electromotive force according to the electric or electromagnetic field detected by the antenna.

This antenna is connected to a power supply box.

The objects placed in or on these supports comprise non-contact labels 14 belonging to the NFC (Near Field Communication) or RFID (Radio Frequency Identification) technologies.

These labels 14 are placed in or on these objects.

The RFID is a wireless communication between the non-contact reading means and the non-contact label.

The RFID technology used by way of example in this invention is of the RFID UHF (Ultra High Frequency 860 MHz to 960 MHz) type.

These non-contact labels 14 comprise means of specification archiving unique information data unique for the object.

The distribution platform comprises the server 6.

This server 6 comprises means of processing able to implement a computer code able to process the data received in such a way as to identify an event relating to an action carried out on an object.

Indeed, the antenna or antennas included in each of the supports for objects are connected to the server 6 using technologies relating to the means of communication 13.

Once they have detected and interrogated the non-contact labels of the objects of a support, they transmit the identifiers of these objects to the server 6.

This server is also connected to a terminal of the cash register type 18 and/or to security passageways 19 using technologies relating to the means of communication 13.

The cash register and/or these security passageways comprise at least one reading means of non-contact labels.

The means of communication 13 connecting in particular the technical platform to the distribution platforms relates to a network corresponding to an Internet network but not exclusively. The data exchanges are carried out under the TCP/IP protocol or other protocols allowing for optimised and reliable data exchange.

The network used relates to means of cabling and/or means of electromagnetic transmission.

Without claiming to provide a complete listing, these means of cabling correspond for example to fibre optics or copper cables, and the means of electromagnetic transmission relate for example to wireless links based on mobile telephone standards such as GSM (acronym for Global System for Mobile Communications), UMTS (acronym for Universal Mobile Telecommunications System), EDGE (acronym for Enhanced Data Rates for GSM Evolution) or HSDPA (acronym for High-Speed Downlink Packet Access). These means can also relate to technologies such as WIFI defined by the IEEE 802.11 standards, or Bluetooth defined by the IEEE 802.15 standards, or to WIMAX (acronym for Worldwide Interoperability for Microwave Access) defined by the IEEE 802.16 standard.

The non-contact label reading means relating in this example to an antenna, detect a set of objects each comprising an RFID label and belonging to the support for objects 3 wherein is placed this antenna 7.

This antenna 7 interrogates via the transmission of a signal, each of the labels and obtains as a response the identification element of each object.

The same applies for the non-contact reading means included in the cash register and/or these security passageways.

The identification elements are transmitted to the server 6, each time that the process relating to the step of detection is carried out.

The data resulting from these steps of detection are saved by the server 6 and associated with a parameter relating to time. This parameter corresponds to the moment when the detection was carried out.

This is for example the date and time that this step of detection was carried out.

This step of detection is carried out continuously. However the cycle of detection can be configured using the technical platform. This configuring makes it possible to space out the steps of detection or bring them closer together.

The server 6 determines event data relating to actions carried out on an object.

These actions correspond for example to a sale of an object, to a consultation of the object by a customer therefore to a removal of the object from the support for objects, or to a theft of an object, or to a change in the support for the object.

These actions are deduced from the processing of the data transmitted to the server 6 by the antenna of the support where the object concerned by the actions is located, but also via other antennas that do not belong to this support.

In an example, where the object is removed from the support, the antenna of this support no longer detects this object, and transmits the identifier of this object to the server 6 which archives it with a time parameter t0 in its database.

At a time t1, the object is detected by the antenna included in the cash register. This antenna in turn transmits the identifier of this object to the server 6 which archives it with a time t1.

The means of processing of this server 6 with regards to the data received relating to the identifier of the object, the time parameter, and the location of the antennas that have transmitted this identifier in time t0 and t1, determines that the object has been removed from the support 3 in order to be sold.

In this precise case, the event then relates to the sale of the object having this identifier.

In another example, the data received relates to the identifier of the object, the time parameter, and the location of the antennas that have transmitted this identifier which, for time t0 corresponds to the antenna of the support, and for time t1 corresponds to the antenna of the passageway placed at the exit of the shop, then the determined event relates to a theft of an object.

Furthermore, these actions then result from the processing of the data transmitted to the server 6 corresponding to the various steps of detection or of the loss of detection by at least one reading means succeeding an initial step of loss of detection of the non-contact label 14 of said object 8 by said at least one non-contact reading means 7 of the support for objects 3 wherein said object 8 is initially located, according to a predefined parameter relating to time.

As soon as an event is determined for an object, the elements relative to this object as well as to the determination of this event which are archived in the database of the server 6, are transmitted to the technical platform, and more particularly to the management server 5.

This management server 5 archives these elements in the database 4.

The management server 5 using these elements knows in real time the state of the actions and events relating to each object and category of objects, as well as the state of the inventory for each category of objects.

This management server is able to generate statistical data correlating the elements relative to each event with the various distribution platforms, and the various categories of objects.

Using this statistical data, criteria can be generated by the means of processing of this management server with the purpose of being applied by the server managing the inventory comprised in the technical platform.

Indeed, these criteria have for function to optimise the management of the inventory, by generating for example queries:
in the direction of the suppliers for new orders relating to an object category, or
in the direction of the server comprised in distribution platforms with the purpose of applying a price drop on an object category which has had few events in terms of sales.

The server 5 comprises means of processing such that at least one processer and means of memory in order to implement the software application, which makes it possible to determine a state of the inventory of the objects at regular and frequent intervals, which can be configured.

As such, each event relating to an object is stored within a database connected to the management server 5.

Using the archived events, the means of processing of the server 5 carry out in real time a comparison of two successive states of inventory relating for example to a display window block, and identifies the objects that are missing, have been added or which have been moved.

In the event of a higher quantity, it compares these differences with previous removals that have not been sold (not taken from stock) and receipts that have been recorded on the distribution platform 2 (the warehouse).

Indeed a new object added to a display window can be either following a return after a demonstration to the customer (movement of the object), or following the reception of new products. If this is not the case, an alert is then generated on server 6 in order to process this abnormal presence. The server 6 issues an alert by transmitting a query to an alert system provided to alert the personnel of the distribution platform 2.

In the event of a lower quantity, the system analyses the potential sales or removal from stock for returns. If this is not the case, after a lapse of time that can be configured (in order to process the cases where the object, here the piece of jewellery, is removed for a customer demonstration) then the server 6 issues an alert by transmitting a query to an alert system provided to alert the personnel of the distribution platform 2.

Using the events archived and transmitted by the server 6, the means of processing of the server 5 compare in a global way for an object or a range of objects the number of removals from the display windows observed over a given period of time (one month, for example) and the number of sales.

The means of processing of this server 5 implement a software application making it possible to determine in an incomplete manner:
the objects that have not been removed frequently, and
the objects that have been tried frequently and among these objects those with a high power of conversion into a sale.

The analysis of statistical elements generated by this server makes it possible to define parameters (or criteria) with the purpose of triggering new orders for the objects with high success or to cancel orders, in order to optimise inventory management, with suppliers. Based on these criteria the server 5 also determines actions that result in:
the modification of the arrangement in the display window blocks of the objects that have the least movement or which are purchased the least, therefore less popular, or
the removal of these objects from the display window block.

Additionally, the means of processing of the server 5 make it possible using these criteria to have indicators that make it possible to carry out an arrangement per display window block and even per sub-display window block.

These criteria make it possible to associate the sales figures and commercial performance per display window because it is possible to determine for each sale from which display window the piece of jewellery comes from.

Note that for each object removed from a plate and detected by the cash register, therefore relating to a sale, the latest removal for the associated RFID tag is archived in the server 6.

Advantageously the invention makes it possible to set up rules for the distribution of objects in the display window blocks. Then at each determination of the contents of the display window blocks, it is possible to compare the actual distribution with the distribution rules in order to check for the correct arrangement in the display window blocks.

The invention offers the advantage of allowing for traceability in real time of the objects, in such a way as to make it possible to better manage the sales of the various categories of objects, to reduce the time devoted to inventory, to control markdowns and top analyse the performance of the distribution platforms.

As such, it is understood that the invention is not limited to the example embodiments described and shown. It is furthermore not limited to these embodiments and to the alternative described.

1-17. (canceled)

18. Method for managing objects arranged on a support and each said object comprising a non-contact label, said method comprising the following steps:
detecting said non-contact labels comprising performing a sub-step of interrogation of said non-contact labels in such a way as to receive identification data of each said object by at least one non-contact reading means;
transmission of said identification data to a server;
determining at least one event relating to said object by a processing means of said server;
transmitting data relating to said at least one event and identification data associated with a technical platform; and
processing of said data relating to said at least one event in such a way as to generate criteria relating to the management of the objects.

19. Method as claimed in claim 18, wherein said detecting step is carried out continuously.

20. Method according to claim 18, wherein said event data relates to actions carried out on an object, deducing said actions from the processing of the data transmitted to the server corresponding to the various steps of detection or of loss of detection by at least one reading means succeeding an initial step of loss of detection of the non-contact label of said object by said at least one non-contact reading means of the support for objects wherein said object is initially located, according to a predefined parameter relating to time.

21. System for managing objects, for the implementation of the method of claim 18, comprising a technical platform connected by a communications network to at least one distribution platform, said at least one distribution platform comprising at least one support for objects connected to a server, said at least one support for objects comprising at least one non-contact reading means arranged in said support in such a way as to receive the data archived in non-contact labels associated with each of the juxtaposed objects comprised in said at least one support for objects, and said at least one distribution platform comprising a server able to exchange data with said technical platform.

22. System as claimed in claim 21, wherein said technical platform comprises a management server and a database comprising information associated with object identifiers.

23. System according to claim 21, wherein said server comprises means for processing able to implement a computer code able to process the data received in such a way as to identify an event relating to an action carried out on an object.

24. System as claimed in claim 21, wherein said distribution platform is a commercial company.

25. System as claimed in claim 21, wherein said support for objects is a display window.

26. System as claimed in claim 21, wherein said non-contact label is a RFID and/or NFC chip.

27. System according to claim 21, wherein said non-contact reading means relates to at least one antenna integrated into the support for objects in such a way that said at least one antenna is not visible.

28. System according to claim 21, wherein said non-contact reading means relates to a plurality of coupled antennas connected to a multiplexer.

29. System according to claim 27, wherein said at least one antenna is made from a flexible material.

30. System according to claim 27, wherein said at least one antenna has a field of detection limited to the volume or to the surface of the support for objects.

31. System according to claim 27, wherein said at least one antenna is connected to the server by wireless communications means.

32. System according to claim 21, wherein the server is comprised in the distribution platform.

33. System according to claim 21, wherein the server is connected to a terminal of the cash register type.

34. System as claimed in claim 33, wherein the terminal comprises a non-contact reading means.
